(19) United States
(12) Patent Application Publication
(10) Pub. No.: US 2025/0088318 A1
(43) Pub. Date: Mar. 13, 2025

(54) METHOD AND APPARATUS FOR TRANSMITTING/RECEIVING SIGNAL IN WIRELESS COMMUNICATION SYSTEM

(71) Applicant: LG ELECTRONICS INC., Seoul (KR)

(72) Inventors: Andrey PUDEEV, Nizhny Novgorod (RU); Alexander MALTSEV, Nizhny Novgorod (RU); Kijun KIM, Seoul (KR); Joonkui AHN, Seoul (KR); Suckchel YANG, Seoul (KR); Seonwook KIM, Seoul (KR)

(73) Assignee: LG ELECTRONICS INC., Seoul (KR)

(21) Appl. No.: 18/290,598

(22) PCT Filed: May 23, 2022
(86) PCT No.: PCT/KR2022/007275

§ 371 Date: Jan. 19, 2024

(30) Foreign Application Priority Data
Sep. 3, 2021 (RU) 2021125997

(51) Int. Cl. H04L 5/00; H04L 27/26

(52) U.S. Cl. CPC H04L 5/001; H04L 5/0048; H04L 27/2607; H04L 27/265

(57) ABSTRACT

According to at least one of embodiments disclosed in the application, a method of receiving a signal by a device in a wireless communication system, may comprise receiving a time-domain signal including one or more orthogonal frequency divisional multiplexing (OFDM) symbols; and obtaining a frequency-domain signal by performing a fast Fourier transform (FFT) based on the time-domain signal, wherein each OFDM symbol in the time-domain signal may include a data part, a cyclic prefix (CP) part, and a time domain reference signal (TDRS) part, wherein the TDRS part may include a known sequence that is predefined for phase noise compensation in a time-domain, and wherein the phase noise compensation can be performed in a symbol level in the time-domain based on the TDRS part in each OFDM symbol.

### TECHNICAL FIELD

The present disclosure relates to a method and an apparatus for transmitting or receiving a time-domain signal based on a novel frame structure in a wireless communication system.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

The present disclosure relates to a method and an apparatus for transmitting or receiving a time-domain signal based on a novel frame structure in a wireless communication system.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

According to an aspect of the present invention, a method of receiving a signal by a device in a wireless communication system, may comprise receiving a time-domain signal including one or more orthogonal frequency divisional multiplexing (OFDM) symbols; and obtaining a frequency-domain signal by performing a fast Fourier transform (FFT) based on the time-domain signal, wherein each OFDM symbol in the time-domain signal may include a data part, a cyclic prefix (CP) part, and a time domain reference signal (TDRS) part, wherein the TDRS part may include a known sequence that is predefined for phase noise compensation in a time-domain, and wherein the phase noise compensation can be performed in a symbol level in the time-domain based on the TDRS part in each OFDM symbol.

Preferably, information regarding a duration of the TDRS part may be obtained through network signaling.

Preferably, the information regarding the duration of the TDRS part may indicate a ratio of the TDRS part and the CP part.

Preferably, the network signaling may be downlink control information (DCI) or radio resource control (RRC) signaling.

Preferably, the TDRS part and the CP part may be configured to share a fixed time duration in each OFDM symbol.

Preferably, the fixed time duration may be identical to a CP duration of a CP-OFDM symbol in which the TDRS part is not configured.

Preferably, both the TDRS part and the data part may be included in a FFT window for performing the FFT.

Preferably, the TDRS part of each OFDM symbol may include one or more sub-parts which are apart from each other.

Preferably, the FFT may be performed by assuming that data puncturing or data rate-matching has been performed for the TDRS part.

A device performing the method of receiving the signal may be provided according to other aspect of the present invention.

According to another aspect of the present invention, a method of transmitting a signal by a device in a wireless communication system, may comprise generating a frequency-domain signal; and transmitting a time-domain signal including one or more orthogonal frequency divisional multiplexing (OFDM) symbols by performing an inverse fast Fourier transform (IFFT) based on the frequency-domain signal, wherein each OFDM symbol in the time-domain signal may include a data part, a cyclic prefix (CP) part, and a time domain reference signal (TDRS) part, and wherein the TDRS part may include a known sequence that is predefined for phase noise compensation in a symbol level in a time-domain.

Preferably, information regarding a duration of the TDRS part may be transmitted through network signaling.

Preferably, the information regarding the duration of the TDRS part may indicate a ratio of the TDRS part and the CP part.

Preferably, the network signaling may be downlink control information (DCI) or radio resource control (RRC) signaling.

Preferably, the TDRS part and the CP part may be configured to share a fixed time duration in each OFDM symbol.

Preferably, the fixed time duration may be identical to a CP duration of a CP-OFDM symbol in which the TDRS part is not configured.

Preferably, the IFFT may be performed after data puncturing or data rate-matching for the TDRS part.

A device performing the method of transmitting the signal may be provided according to another aspect of the present invention.

### Advantageous Effects

According to embodiments of the present disclosure, a time-domain reference signal may be efficiently transmitted and received based on a novel frame structure in sub-THz band.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included to provide a further understanding of the disclosure, illustrate embodiments of the disclosure and together with the description serve to explain the principle of the disclosure.

In the drawings:

FIG. 1 illustrates physical channels and a general signal transmission method using the physical channels in a 3rd generation partnership project (3GPP) system as an exemplary wireless communication system;

FIG. 2 illustrates network initial access and a subsequent communication process;

FIG. 3 illustrates a discontinuous reception (DRX) cycle;

FIG. 4 illustrates a radio frame structure;

FIG. 5 illustrates a resource grid during the duration of a slot;

FIG. 6 illustrates exemplary mapping of physical channels in a slot;

FIG. 7 illustrates exemplary uplink (UL) transmission operations of a user equipment (UE);

FIG. 8 illustrates exemplary repeated transmissions based on a configured grant;

FIG. 9 illustrates a wireless communication system supporting an unlicensed band;

FIG. 10 illustrates examples waveforms in time domain;

FIG. 11 illustrates proposed TDRS waveforms in embodiments of the present invention;

FIG. 12 illustrates TDRS-CP-OFDM processing according to an embodiment of the present invention.

FIG. 13 illustrates TDRS OFDM processing according to an embodiment of the present invention.

FIG. 14 illustrates CP-TDRS-OFDM processing according to an embodiment of the present invention.

FIG. 15 illustrates a method of transmitting or receiving a signal according to an embodiment of the present invention.

FIG. 16 illustrates an exemplary communication system applied to the present disclosure;

FIG. 17 illustrates an exemplary wireless device applicable to the present disclosure;

FIG. 18 illustrates another exemplary wireless device applicable to the present disclosure; and

FIG. 19 illustrates an exemplary vehicle or autonomous driving vehicle applicable to the present disclosure.

### MODE FOR INVENTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

As more and more communication devices require larger communication capacities, the need for enhanced mobile broadband communication relative to the legacy radio access technologies (RATs) has emerged. Massive machine type communication (MTC) providing various services to inter-connected multiple devices and things at any time in any place is one of significant issues to be addressed for next-generation communication. A communication system design in which services sensitive to reliability and latency are considered is under discussion as well. As such, the introduction of the next-generation radio access technology (RAT) for enhanced mobile broadband communication (eMBB), massive MTC (mMTC), and ultra-reliable and low latency communication (URLLC) is being discussed. For convenience, this technology is called NR or New RAT in the present disclosure.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 3GPP TS 38.211, 38.212, 38.213, 38.214, 38.300, 38.331, and so on).

Also, following documents can be incorporated by references:
[1] RP-200902, Study on supporting NR from 52.6 GHz to 71 GHz;
[2] D. Van Welden, H. Steendam and M. Moeneclaey, “Time delay estimation for KSP-OFDM systems in multipath fading channels,” in Proceedings of the 20th Personal, Indoor and Mobile Radio Communications Symposium, 2009. PIMRC-09, September 2009;
[3] D. Van Welden, H. Steendam and M. Moeneclaey, “Frequency-domain data-aided channel estimation for ksp-ofdm,” in Proc. from 10th International Symposium on Spread Spectrum Techniques and Applications (ISSSTA′08), Bologna, Italy, August 2008;
[4] S. Tang, F. Yang, K. Peng, C. Pan, K. Gong, Z. Yang, “Iterative channel estimation for block transmission with known symbol padding-a new look at TDS-OFDM,” in the Proceedings of the IEEE Global Telecommunications Conference (GLOBECOM 2007), pp. 4269-4273 November 2007;
[5] M. Huemer, C. Hofbauer, J. B. Huber, “The Potential of Unique Words in OFDM,” in the Proceedings of the 15th International OFDM-Workshop, Hamburg, Germany, pp. 140-144, September 2010; and
[6] 3GPP TS 38.331 version 15.7.0, Rel-15, “5G NR Radio Resource Control (RRC) Protocol specification”.

In a wireless access system, a user equipment (UE) receives information from a base station (BS) on DL and transmits information to the BS on UL. The information transmitted and received between the UE and the BS includes general data and various types of control information. There are many physical channels according to the types/usages of information transmitted and received between the BS and the UE.

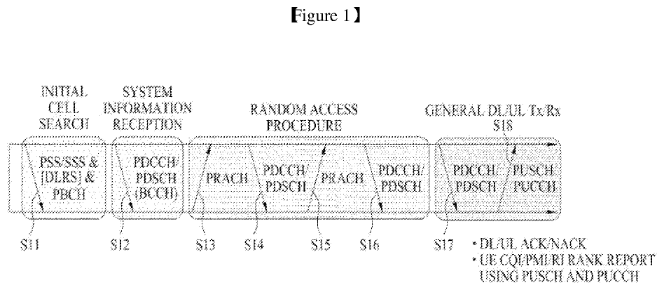

FIG. 1 illustrates physical channels and a general signal transmission method using the physical channels in a 3GPP system.

When a UE is powered on or enters a new cell, the UE performs initial cell search (S11). The initial cell search involves acquisition of synchronization to a BS. For this purpose, the UE receives a synchronization signal block (SSB) from the BS. The SSB includes a primary synchronization signal (PSS), a secondary synchronization signal (SSS), and a physical broadcast channel (PBCH). The UE synchronizes its timing to the BS and acquires information such as a cell identifier (ID) based on the PSS/SSS. Further, the UE may acquire information broadcast in the cell by receiving the PBCH from the BS. During the initial cell search, the UE may also monitor a DL channel state by receiving a downlink reference signal (DL RS).

After the initial cell search, the UE may acquire more detailed system information by receiving a physical downlink control channel (PDCCH) and a physical downlink shared channel (PDSCH) corresponding to the PDCCH (S12).

Subsequently, to complete connection to the BS, the UE may perform a random access procedure with the BS (S13 to S16). Specifically, the UE may transmit a preamble on a physical random access channel (PRACH) (S13) and may receive a PDCCH and a random access response (RAR) for the preamble on a PDSCH corresponding to the PDCCH (S14). The UE may then transmit a physical uplink shared channel (PUSCH) by using scheduling information in the RAR (S15), and perform a contention resolution procedure including reception of a PDCCH and a PDSCH signal corresponding to the PDCCH (S16).

When the random access procedure is performed in two steps, steps S13 and S15 may be performed as one step (in which Message A is transmitted by the UE), and steps S14 and S16 may be performed as one step (in which Message B is transmitted by the BS).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure. Control information that the UE transmits to the BS is generically called uplink control information (UCI). The UCI includes a hybrid automatic repeat and request acknowledgement/negative acknowledgement (HARQ-ACK/NACK), a scheduling request (SR), channel state information (CSI), and so on. The CSI includes a channel quality indicator (CQI), a precoding matrix index (PMI), a rank indication (RI), and so on. In general, UCI is transmitted on a PUCCH. However, if control information and data should be transmitted simultaneously, the control information and the data may be transmitted on a PUSCH. In addition, the UE may transmit the UCI aperiodically on the PUSCH, upon receipt of a request/command from a network.

The UE may perform a network access procedure to perform the described/proposed procedures and/or methods. For example, the UE may receive and store system information and configuration information required to perform the above-described/proposed procedures and/or methods during network (e.g., BS) access. The configuration information required for the present disclosure may be received by higher-layer signaling (e.g., radio resource control (RRC) signaling, medium access control (MAC) signaling, or the like).

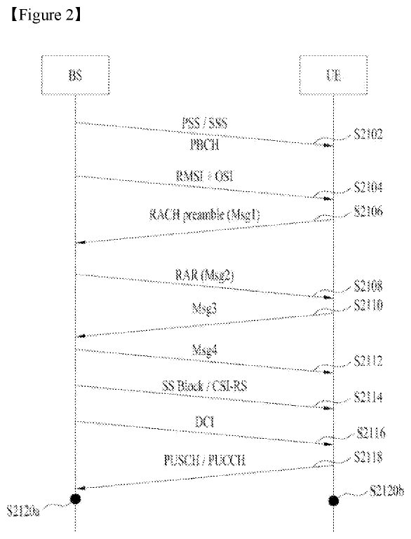

FIG. 2 is a diagram illustrating a signal flow for network initial access and a subsequent communication process. In NR, a physical channel and an RS may be transmitted by beamforming. When beamforming-based signal transmission is supported, a beam management process may be performed to align beams between a BS and a UE. Further, a signal proposed in the present disclosure may be transmitted/received by beamforming. In RRC_IDLE mode, beam alignment may be performed based on an SSB, whereas in RRC_CONNECTED mode, beam alignment may be performed based on a channel state information reference signal (CSI-RS) (in DL) and a sounding reference signal (SRS) (in UL). When beamforming-based signal transmission is not supported, a beam-related operation may be skipped in the following description.

Referring to FIG. 2, a BS may periodically transmit an SSB (S2102). The SSB includes a PSS/SSS/PBCH. The SSB may be transmitted by beam sweeping. Subsequently, the BS may transmit remaining minimum system information (RMSI) and other system information (OSI) (S2104). The RMSI may include information (e.g., PRACH configuration information) required for a UE to initially access the BS. After SSB detection, the UE identifies a best SSB. The UE may then transmit an RACH preamble (Message 1 (Msg 1)) to the BS in PRACH resources linked/corresponding to the index (i.e., beam) of the best SSB (S2106). The beam direction of the RACH preamble is associated with the PRACH resources. The association between the PRACH resources (and/or RACH preamble) and the SSB (index) may be configured by system information (e.g., RMSI). Subsequently, as a part of the RACH process, the BS may transmit an RAR (Msg 2) in response to the RACH preamble (S2108), and the UE may transmit Msg 3 (e.g., RRC Connection Request) using a UL grant in the RAR (S2110). The BS may transmit a contention resolution message (Msg 4) (S2112). Msg 4 may include an RRC Connection Setup message. Msg 1 and Msg 3 may be combined (e.g., into Msg A) and transmitted in one step, and Msg 2 and Msg 4 may be combined (e.g., into Msg B) and transmitted in one step.

When an RRC connection is established between the BS and the UE through the RACH process, subsequent beam alignment may be performed based on an SSB/CSI-RS (in DL) and an SRS (in UL). For example, the UE may receive the SSB/CSI-RS (S2114). The UE may use the SSB/CSI-RS to generate a beam/CSI report. The BS may request a beam/CSI report to the UE by downlink control information (DCI) (S2116). In this case, the UE may generate a beam/CSI report based on the SSB/CSI-RS, and transmit the generated beam/CSI report to the BS on a PUSCH/PUCCH (S2118). The beam/CSI report may include a beam measurement result, preferred beam information, and the like. The BS and the UE may switch beams based on the beam/CSI report (S2120a and S2120b).

Subsequently, the UE and the BS may perform the later-described/proposed procedures and/or methods (FIGS. 11 to 18). For example, the UE and the BS may process information stored in memories and transmit a wireless signal or process a received wireless signal and store the processed wireless signal in the memories, according to a proposal in the present disclosure based on configuration information obtained during the network access procedure (e.g., the system information acquisition process, the RRC connection process through an RACH, and so on). The wireless signal may include at least one of a PDCCH, a PDSCH, or an RS on DL, and at least one of a PUCCH, a PUSCH, or an SRS on UL.

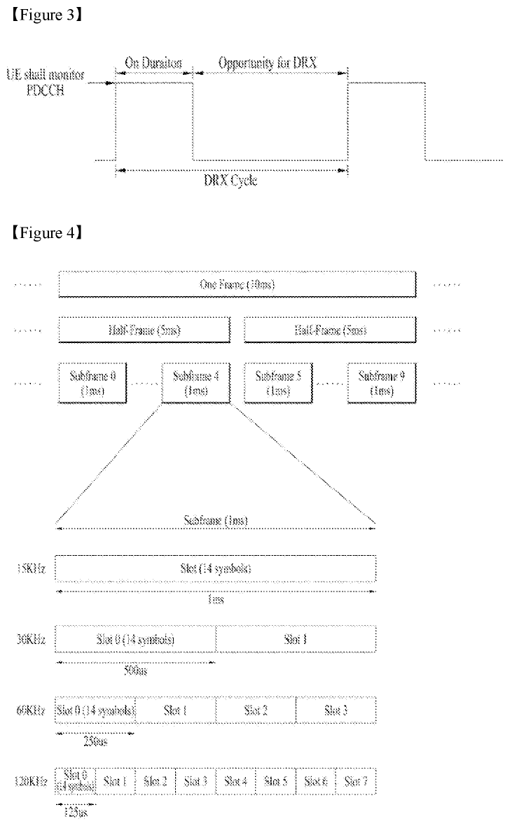

FIG. 3 is a diagram illustrating a DRX cycle (RRC_CONNECTED state).

Referring to FIG. 3, the DRX cycle includes On Duration and Opportunity for DRX. The DRX cycle defines a time interval in which On Duration is periodically repeated. On Duration is a time period during which the UE monitors to receive a PDCCH. When DRX is configured, the UE performs PDCCH monitoring during the On Duration. When there is any successfully detected PDCCH during the PDCCH monitoring, the UE operates an inactivity timer and is maintained in an awake state. On the other hand, when there is no successfully detected PDCCH during the PDCCH monitoring, the UE enters a sleep state, when the On Duration ends. Therefore, if DRX is configured, PDCCH monitoring/reception may be performed discontinuously in the time domain, when the afore-described/proposed procedures and/or methods are performed. For example, if DRX is configured, PDCCH reception occasions (e.g., slots having PDCCH search spaces) may be configured discontinuously according to a DRX configuration in the present disclosure. On the contrary, if DRX is not configured, PDCCH monitoring/reception may be performed continuously in the time domain, when the afore-described/proposed procedures and/or methods are performed. For example, if DRX is not configured, PDCCH reception occasions (e.g., slots having PDCCH search spaces) may be configured continuously in the present disclosure. PDCCH monitoring may be limited in a time period configured as a measurement gap, irrespective of whether DRX is configured.

Table 1 describes a UE operation related to DRX (in the RRC_CONNECTED state). Referring to Table 1, DRX configuration information is received by higher-layer (RRC) signaling, and DRX ON/OFF is controlled by a DRX command of the MAC layer. Once DRX is configured, the UE may perform PDCCH monitoring discontinuously in performing the described/proposed procedures and/or methods according to the present disclosure, as illustrated in FIG. 3.

TABLE 1

| | Type of signals | UE procedure |
|---|---|---|
| 1^{st} step | RRC signalling (MAC- | Receive DRX configuration |
| | CellGroupConfig) | information |
| 2^{nd} Step | MAC CE ((Long) DRX | Receive DRX command |
| | command MAC CE) | |
| 3^{rd} Step | — | Monitor a PDCCH during an |
| | | on-duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the length of the starting duration of a DRX cycle.
Value of drx-InactivityTimer: defines the length of a time duration in which the UE is in the awake state after a PDCCH occasion in which a PDCCH indicating initial UL or DL data has been detected.
Value of drx-HARQ-RTT-TimerDL: defines the length of a maximum time duration from reception of a DL initial transmission to reception of a DL retransmission.
Value of drx-HARQ-RTT-TimerDL: defines the length of a maximum time duration from reception of a grant for a DL initial transmission to reception of a grant for a UL retransmission.
drx-LongCycleStartOffset: defines the time duration and starting time of a DRX cycle.
drx-ShortCycle (optional): defines the time duration of a short DRX cycle.

When at least one of drx-OnDurationTimer, drx-InactivityTimer, drx-HARQ-RTT-TimerDL, or drx-HARQ-RTT-TimerDL is running, the UE performs PDCCH monitoring in each PDCCH occasion, while staying in the awake state.

For example, according to an embodiment of the present disclosure, when DRX is configured for a UE of the present disclosure, the UE may receive a DL signal during On Duration.

FIG. 4 illustrates a radio frame structure.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM(A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 2 exemplarily illustrates that the number of symbols per slot, the number of slots per frame, and the number of slots per subframe vary according to SCSs in a normal CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: number of symbols in a slot
* N^{frame, u}ₛₗₒₜ: number of slots in a frame
* N^{subframe, u}ₛₗₒₜ: number of slots in a subframe

Table 3 illustrates that the number of symbols per slot, the number of slots per frame, and the number of slots per subframe vary according to SCSs in an extended CP case.

TABLE 3

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example, and the number of subframes, the number of slots, and the number of symbols in a frame may be changed in various manners.

In the NR system, different OFDM(A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, frequency range 1 (FR1) and FR2. FR1 and FR2 may be configured as described in Table 4 below. FR2 may be millimeter wave (mmW).

TABLE 4

| Frequency Range | Corresponding | Subcarrier |
|---|---|---|
| designation | frequency range | Spacing (SCS) |
| FR1 | 450 MHz-7125 MHz | 15, 30, 60 kHz |
| FR2 | 24250 MHz-52600 MHz | 60, 120, 240 kHz |

Meanwhile, phase noise generated by non-ideal oscillators is a serious problem, particularly in the higher frequency bands such as mmWave or FR2. To compensate for phase noise, PTRS is employed in 5G NR wireless communication system Rel. 16. The PTRS can also be used to compliment the DMRS. UE can estimate and subsequently compensate for both phase noise and (Doppler) frequency offsets based on DL PTRS. PTRS has a relatively high density in the time domain and a relatively low density in the frequency domain. Table 8 is UE's PTRS reception procedure defined in 3GPP TS 38.214 Rel. 16.

In 5G NR Std. (TS38.211 s5.3), the OFDM baseband signal (except PRACH and remote interference management-RS) is generated as follows:
The time-continuous signal s₁^{(p,μ)}(t) on antenna port p and subcarrier spacing configuration μ for OFDM symbol/∈{0,1, . . . , Nₛₗₒₜ^{subframe,μ}N_{symb}^{slot}−1} in a subframe for any physical channel or signal except PRACH is defined by Equation 1, where, Nₛₗₒₜ^{subframe,μ} denotes the number of slots per subframe for μ (SCS), N_{symb}^{slot} denotes the number of symbols per slot.

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix} \qquad [ Equation 1 ]$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{CP , l}^{μ} {T}_{c} - {t}_{start , l}^{μ} )}$$

$${k}_{0}^{μ} = ( {N}_{grid , x}^{size , μ} + {N}_{grid , x}^{size , μ} / 2 ) {N}_{sc}^{RB} - ( {N}_{grid , x}^{size , {μ}_{0}} + {N}_{grid , x}^{size , {μ}_{0}} / 2 ) {N}_{sc}^{RB} {2}^{{μ}_{0} - μ}$$

$${T}_{symb , l}^{μ} = ( {N}_{u}^{μ} + {N}_{CP , l}^{μ} ) {T}_{c}$$

where t=0 at the start of the subframe,

In Equation 1, T^{u}_{sym,1} is a time length of a symbol l for μ, and Tc is as basic time unit for NR (e.g., time interval between samples of a FFT size 4096 with SCS 480 kHz). Nᵤ^{μ} and N_{cp,1}^{μ} are defined as Equation 2.

$${N}_{u}^{μ} = 2048 κ \cdot {2}^{- μ} \qquad [ Equation 2 ]$$

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {2}^{- μ} & normal cyclic prefix , l = 0 and l \neq 7 \cdot {2}^{μ}\end{matrix}$$

In Equation 2, N_{cp,1}^{μ} is a CP length of a symbol l for μ.

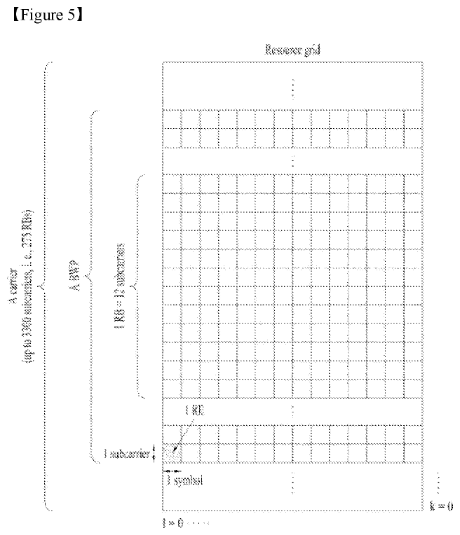

FIG. 5 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A bandwidth part (BWP) may be defined by a plurality of consecutive (physical) RBs ((P) RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

FIG. 6 illustrates exemplary mapping of physical channels in a slot.

A DL control channel, DL or UL data, and a UL control channel may all be included in one slot. For example, the first N symbols (hereinafter, referred to as a DL control region) in a slot may be used to transmit a DL control channel, and the last M symbols (hereinafter, referred to as a UL control region) in the slot may be used to transmit a UL control channel. N and M are integers equal to or greater than 0. A resource region (hereinafter, referred to as a data region) between the DL control region and the UL control region may be used for DL data transmission or UL data transmission. A time gap for DL-to-UL or UL-to-DL switching may be defined between a control region and the data region. A PDCCH may be transmitted in the DL control region, and a PDSCH may be transmitted in the DL data region. Some symbols at the time of switching from DL to UL in a slot may be configured as the time gap.

Now, a detailed description will be given of physical channels.

The PDSCH delivers DL data (e.g., a downlink shared channel (DL-SCH) transport block (TB)) and adopts a modulation scheme such as quadrature phase shift keying (QPSK), 16-ary quadrature amplitude modulation (16 QAM), 64-ary QAM (64 QAM), or 256-ary QAM (256 QAM). A TB is encoded to a codeword. The PDSCH may deliver up to two codewords. The codewords are individually subjected to scrambling and modulation mapping, and modulation symbols from each codeword are mapped to one or more layers. An OFDM signal is generated by mapping each layer together with a DMRS to resources, and transmitted through a corresponding antenna port.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI). The PDCCH uses a fixed modulation scheme (e.g., QPSK). One PDCCH includes 1, 2, 4, 8, or 16 control channel elements (CCEs) according to its aggregation level (AL). One CCE includes 6 resource element groups (REGs), each REG being defined by one OFDM symbol by one (P) RB.

The PDCCH is transmitted in a control resource set (CORESET). The CORESET corresponds to a set of physical resources/parameters used to deliver the PDCCH/DCI in a BWP. For example, the CORESET is defined as a set of REGs with a given numerology (e.g., an SCS, a CP length, or the like). The CORESET may be configured by system information (e.g., a master information block (MIB)) or UE-specific higher-layer signaling (e.g., RRC signaling). For example, the following parameters/information may be used to configure a CORESET, and a plurality of CORESETs may overlap with each other in the time/frequency domain.
controlResourceSetId: indicates the ID of a CORESET.
frequencyDomainResources: indicates the frequency area resources of the CORESET. The frequency area resources are indicated by a bitmap, and each bit of the bitmap corresponds to an RB group (i.e., six consecutive RBs). For example, the most significant bit (MSB) of the bitmap corresponds to the first RB group of a BWP. An RB group corresponding to a bit set to 1 is allocated as frequency area resources of the CORESET.
duration: indicates the time area resources of the CORESET. It indicates the number of consecutive OFDMA symbols in the CORESET. For example, the duration is set to one of 1 to 3.
cce-REG-MappingType: indicates a CCE-to-REG mapping type. An interleaved type and a non-interleaved type are supported.
precoderGranularity: indicates a precoder granularity in the frequency domain.
tci-StatesPDCCH: provides information indicating a transmission configuration indication (TCI) state for the PDCCH (e.g., TCI-StateID). The TCI state is used to provide the quasi-co-location relation between DL RS(s) in an RS set (TCI-state) and PDCCH DMRS ports.
tci-PresentInDCI: indicates whether a TCI field is included in DCI.
pdcch-DMRS-ScramblingID: provides information used for initialization of a PDCCH DMRS scrambling sequence.

To receive the PDCCH, the UE may monitor (e.g., blind-decode) a set of PDCCH candidates in the CORESET. The PDCCH candidates are CCE(s) that the UE monitors for PDCCH reception/detection. The PDCCH monitoring may be performed in one or more CORESETs in an active DL BWP on each active cell configured with PDCCH monitoring. A set of PDCCH candidates monitored by the UE is defined as a PDCCH search space (SS) set. The SS set may be a common search space (CSS) set or a UE-specific search space (USS) set.

Table 5 lists exemplary PDCCH SSs.

TABLE 5

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg 2, Msg 4 |
| PDCCH | | primary cell | decoding in |
| | | | RACH |
| Type2- | Common | P-RNTI on a primary cell | Paging Decoding |
| PDCCH | | | |
| Type3- | Common | INT-RNTI, SFI-RNTI, TPC- | |
| PDCCH | | PUSCH-RNTI, TPC-PUCCH- | |
| | | RNTI, TPC-SRS-RNTI, C-RNTI, | |
| | | MCS-C-RNTI, or CS-RNTI(s) | |
| UE Specific | UE Specific | C-RNTI, or MCS-C-RNTI, or CS- | User specific |
| | | RNTI(s) | PDSCH decoding |

The SS set may be configured by system information (e.g., MIB) or UE-specific higher-layer (e.g., RRC) signaling. S or fewer SS sets may be configured in each DL BWP of a serving cell. For example, the following parameters/information may be provided for each SS set. Each SS set may be associated with one CORESET, and each CORESET configuration may be associated with one or more SS sets.
searchSpaceId: indicates the ID of the SS set.
controlResourceSetId: indicates a CORESET associated with the SS set.
monitoringSlotPeriodicity AndOffset: indicates a PDCCH monitoring periodicity (in slots) and a PDCCH monitoring offset (in slots).
monitoringSymbolsWithinSlot: indicates the first OFDMA symbol(s) for PDCCH monitoring in a slot configured with PDCCH monitoring. The OFDMA symbols are indicated by a bitmap and each bit of the bitmap corresponds to one OFDM symbol in the slot. The MSB of the bitmap corresponds to the first OFDM symbol of the slot. OFDMA symbol(s) corresponding to bit(s) set to 1 corresponds to the first symbol(s) of the CORESET in the slot.
nrofCandidates: indicates the number of PDCCH candidates (e.g., one of 0, 1, 2, 3, 4, 5, 6, and 8) for each AL={1, 2, 4, 8, 16}.
searchSpaceType: indicates whether the SS type is CSS or USS.
DCI format: indicates the DCI format of PDCCH candidates.

The UE may monitor PDCCH candidates in one or more SS sets in a slot based on a CORESET/SS set configuration. An occasion (e.g., time/frequency resources) in which the PDCCH candidates should be monitored is defined as a PDCCH (monitoring) occasion. One or more PDCCH (monitoring) occasions may be configured in a slot.

Table 6 illustrates exemplary DCI formats transmitted on the PDCCH.

TABLE 6

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) |
| | and OFDM symbol(s) where UE may assume |
| | no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

The PUCCH delivers uplink control information (UCI). The UCI includes the following information.
SR: information used to request UL-SCH resources.
HARQ-ACK: a response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.
CSI: feedback information for a DL channel. Multiple input multiple output (MIMO)-related feedback information includes an RI and a PMI.

Table 7 illustrates exemplary PUCCH formats. PUCCH formats may be divided into short PUCCHs (Formats 0 and 2) and long PUCCHs (Formats 1, 3, and 4) based on PUCCH transmission durations.

TABLE 7

| | Length in | | | |
|---|---|---|---|---|
| | OFDM | | | |
| PUCCH | symbols | Number of | | |
| format | N_{symb}^{PUCCH} | bits | Usage | Etc |
| 0 | 1-2 | ≤2 | HARQ, SR | Sequence selection |
| 1 | 4-14 | ≤2 | HARQ, [SR] | Sequence modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE multiplexing) |
| 4 | 4-14 | >2 | HARQ, CSI, | DFT-s-OFDM |
| | | | [SR] | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in PUCCH resources for a corresponding SR configuration.

PUCCH format 1 conveys UCI of up to 2 bits and modulation symbols of the UCI are spread with an orthogonal cover code (OCC) (which is configured differently whether frequency hopping is performed) in the time domain. The DMRS is transmitted in a symbol in which a modulation symbol is not transmitted (i.e., transmitted in time division multiplexing (TDM)). PUCCH format 2 conveys UCI of more than 2 bits and modulation symbols of the DCI are transmitted in frequency division multiplexing (FDM) with the DMRS. The DMRS is located in symbols #1, #4, #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBS, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBS, and conveys UCI of more than 2 bits. In other words, PUCCH resources of PUCCH format 3 include an OCC. Modulation symbols are transmitted in TDM with the DMRS.

The PUSCH delivers UL data (e.g., UL-shared channel transport block (UL-SCH TB)) and/or UCI based on a CP-OFDM waveform or a DFT-s-OFDM waveform. When the PUSCH is transmitted in the DFT-s-OFDM waveform, the UE transmits the PUSCH by transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. A PUSCH transmission may be dynamically scheduled by a UL grant in DCI, or semi-statically scheduled by higher-layer (e.g., RRC) signaling (and/or Layer 1 (L1) signaling such as a PDCCH) (configured scheduling or configured grant). The PUSCH transmission may be performed in a codebook-based or non-codebook-based manner.

On DL, the BS may dynamically allocate resources for DL transmission to the UE by PDCCH(s) (including DCI format 1_0 or DCI format 1_1). Further, the BS may indicate to a specific UE that some of resources pre-scheduled for the UE have been pre-empted for signal transmission to another UE, by PDCCH(s) (including DCI format 2_1). Further, the BS may configure a DL assignment periodicity by higher-layer signaling and signal activation/deactivation of a configured DL assignment by a PDCCH in a semi-persistent scheduling (SPS) scheme, to provide a DL assignment for an initial HARQ transmission to the UE. When a retransmission for the initial HARQ transmission is required, the BS explicitly schedules retransmission resources through a PDCCH. When a DCI-based DL assignment collides with an SPS-based DL assignment, the UE may give priority to the DCI-based DL assignment.

Similarly to DL, for UL, the BS may dynamically allocate resources for UL transmission to the UE by PDCCH(s) (including DCI format 0_0 or DCI format 0_1). Further, the BS may allocate UL resources for initial HARQ transmission to the UE based on a configured grant (CG) method (similarly to SPS). Although dynamic scheduling involves a PDCCH for a PUSCH transmission, a configured grant does not involve a PDCCH for a PUSCH transmission. However, UL resources for retransmission are explicitly allocated by PDCCH(s). As such, an operation of preconfiguring UL resources without a dynamic grant (DG) (e.g., a UL grant through scheduling DCI) by the BS is referred to as a “CG”. Two types are defined for the CG.
Type 1: a UL grant with a predetermined periodicity is provided by higher-layer signaling (without L1 signaling).
Type 2: the periodicity of a UL grant is configured by higher-layer signaling, and activation/deactivation of the CG is signaled by a PDCCH, to provide the UL grant.

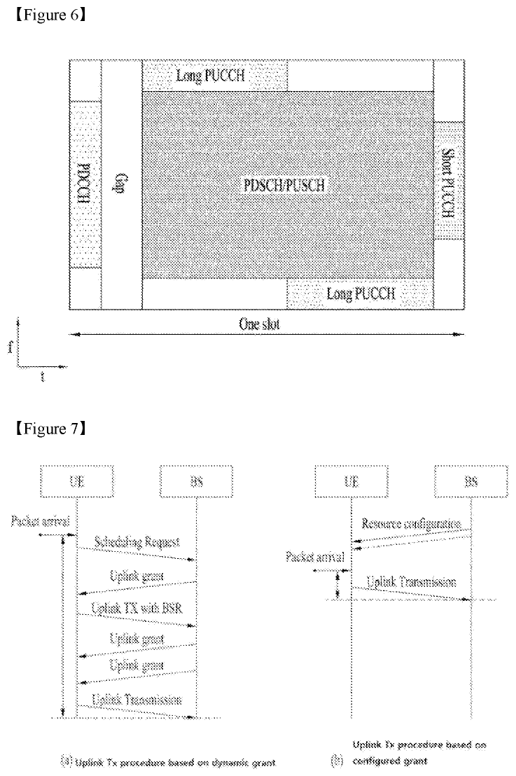

FIG. 7 illustrates exemplary UL transmission operations of a UE. The UE may transmit an intended packet based on a DG (FIG. 7(a)) or based on a CG (FIG. 7(b)).

Resources for CGs may be shared between a plurality of UEs. A UL signal transmission based on a CG from each UE may be identified by time/frequency resources and an RS parameter (e.g., a different cyclic shift or the like). Therefore, when a UE fails in transmitting a UL signal due to signal collision, the BS may identify the UE and explicitly transmit a retransmission grant for a corresponding TB to the UE.

K repeated transmissions including an initial transmission are supported for the same TB by a CG. The same HARQ process ID is determined for K times repeated UL signals based on resources for the initial transmission. The redundancy versions (RVs) of a K times repeated TB have one of the patterns {0, 2, 3, 1}, {0, 3, 0, 3}, and {0, 0, 0, 0}.

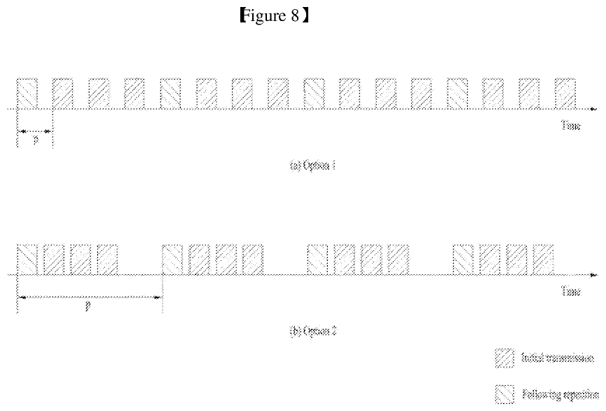

FIG. 8 illustrates exemplary repeated transmissions based on a CG.

The UE performs repeated transmissions until one of the following conditions is satisfied:
A UL grant for the same TB is successfully received;
The repetition number of the TB reaches K; and
(In Option 2) the ending time of a period P is reached.

When there are UL/DL transmission data for multiple UEs in a wireless communication system, the BS selects a UE for data transmission in each TTI (e.g., slot). In a multi-carrier system and a similar system, the BS selects UEs for UL/DL data transmission and also selects frequency bands to be used for the data transmission for the UEs.

From the perspective of UL, the UEs transmit RSs (or pilots) on UL. The BS then determines the channel states of the UEs based on the RSs received from the UEs and selects UEs for UL data transmission in respective unit frequency bands in each TTI. The BS indicates these results to the UEs. That is, the BS transmits a UL assignment message requesting data transmission in a specific frequency band to a UE which has been scheduled for UL transmission in a specific TTI. The UL assignment message is also called a UL grant. The UE transmits data on UL according to the UL assignment message. The UL assignment message may include a UE ID, RB allocation information, a modulation and coding scheme (MCS), an RV, a new data indication (NDI), and so on.

In synchronous HARQ, a retransmission timing is pre-agreed at a system level (e.g., 4 subframes after a NACK reception time). Accordingly, the BS transmits a UL grant message to the UE only at an initial transmission, and subsequent retransmissions are performed based on an ACK/NACK signal (e.g., PHICH signal). In asynchronous HARQ, a retransmission timing is not agreed between the BS and the UE, and thus the BS should transmit a retransmission request message to the UE. Further, in non-adaptive HARQ, the same frequency resources and the same MCS may be used for a previous transmission and a retransmission, whereas in adaptive HARQ, different frequency resources and different MCSs may be used for a previous transmission and a retransmission. In asynchronous adaptive HARQ, for example, retransmission frequency resources or a retransmission MCS is changed at each transmission time. Therefore, a retransmission request message may include a UE ID, RB allocation information, an HARQ process ID/number, an RV, and NDI information.

In NR, a dynamic HARQ-ACK codebook scheme and semi-static HARQ-ACK codebook scheme are supported. The term HARQ-ACK (or A/N) codebook may be replaced with HARQ-ACK payload.

When the dynamic HARQ-ACK codebook scheme is configured, the size of A/N payload varies according to the amount of actually scheduled DL data. For this purpose, a PDCCH related to DL scheduling includes a counter-downlink assignment index (DAI) and a total-DAI. The counter-DAI indicates a {CC, slot} scheduling order calculated in a component carrier (CC) (or cell)-first manner and is used to indicate the position of an A/N bit in an A/N codebook. The total-DAI indicates a slot-level scheduling accumulative value up to the current slot and is used to determine the size of the A/N codebook.

When the semi-static HARQ-ACK codebook scheme is configured, the size of an A/N codebook is fixed (to a maximum value) irrespective of the amount of actually scheduled DL data. Specifically, (a maximum) A/N payload (size) transmitted on one PUCCH in one slot may be determined to be the number of A/N bits corresponding to combinations (hereinafter, referred to as a bundling window) of all CCs configured for the UE and DL scheduling slots (or PDSCH transmission slots to PDCCH monitoring slots) available as the A/N transmission timing. For example, DL grant DCI (PDCCH) may include PDSCH-to-A/N timing information, and the PDSCH-to-A/N timing information may have one (e.g., k) of a plurality of values. For example, when a PDSCH is received in slot #m and PDSCH-to-A/N timing information in DL grant DCI (PDCCH) that schedules the PDSCH indicates k, A/N information for the PDSCH may be transmitted in slot #(m+k). For example, k∈{1, 2, 3, 4, 5, 6, 7, 8}. When A/N information is transmitted in slot #n, the A/N information may include as many A/Ns as possible based on a bundling window. That is, the A/N information in slot #n may include an A/N corresponding to slot #(n-k). For example, when k∈{1, 2, 3, 4, 5, 6, 7, 8}, the A/N information in slot #n includes A/Ns (i.e., a maximum number of A/Ns) corresponding to slot #(n-8) to slot #(n-1) irrespective of actual DL data reception. A/N information may be replaced with A/N codebook or A/N payload. Further, a slot may be understood as/replaced with a candidate occasion for DL data reception. As in the example, the bundling window may be determined based on a PDSCH-to-A/N timing based on an A/N slot, and a PDSCH-to-A/N timing set may have predefined values (e.g., {1, 2, 3, 4, 5, 6, 7, 8}) or may be configured by higher-layer (RRC) signaling.

Similarly to licensed-assisted access (LAA) in the legacy 3GPP LTE system, use of an unlicensed band for cellular communication is also under consideration in a 3GPP NR system. Unlike LAA, a stand-along (SA) operation is aimed in an NR cell of an unlicensed band (hereinafter, referred to as NR unlicensed cell (UCell)). For example, PUCCH, PUSCH, and PRACH transmissions may be supported in the NR UCell.

In an NR system to which various embodiments of the present disclosure are applicable, up to 400 MHz per component carrier (CC) may be allocated/supported. When a UE operating in such a wideband CC always operates with a radio frequency (RF) module turned on for the entire CC, battery consumption of the UE may increase.

Alternatively, considering various use cases (e.g., eMBB, URLLC, mMTC, and so on) operating within a single wideband CC, a different numerology (e.g., SCS) may be supported for each frequency band within the CC.

Alternatively, each UE may have a different maximum bandwidth capability.

In this regard, the BS may indicate to the UE to operate only in a partial bandwidth instead of the total bandwidth of the wideband CC. The partial bandwidth may be defined as a bandwidth part (BWP).

A BWP may be a subset of contiguous RBs on the frequency axis. One BWP may correspond to one numerology (e.g., SCS, CP length, slot/mini-slot duration, and so on). The BS may configure multiple BWPs in one CC configured for the UE. For example, the BS may configure a BWP occupying a relatively small frequency area in a PDCCH monitoring slot, and schedule a PDSCH indicated (or scheduled) by a PDCCH in a larger BWP. Alternatively, when UEs are concentrated on a specific BWP, the BS may configure another BWP for some of the UEs, for load balancing. Alternatively, the BS may exclude some spectrum of the total bandwidth and configure both-side BWPs of the cell in the same slot in consideration of frequency-domain inter-cell interference cancellation between neighboring cells.

The BS may configure at least one DL/UL BWP for a UE associated with the wideband CC, activate at least one of DL/UL BWP(s) configured at a specific time point (by L1 signaling (e.g., DCI), MAC signaling, or RRC signaling), and indicate switching to another configured DL/UL BWP (by L1 signaling, MAC signaling, or RRC signaling). Further, upon expiration of a timer value (e.g., a BWP inactivity timer value), the UE may switch to a predetermined DL/UL BWP. The activated DL/UL BWP may be referred to as an active DL/UL BWP. During initial access or before an RRC connection setup, the UE may not receive a configuration for a DL/UL BWP from the BS. A DL/UL BWP that the UE assumes in this situation is defined as an initial active DL/UL BWP.

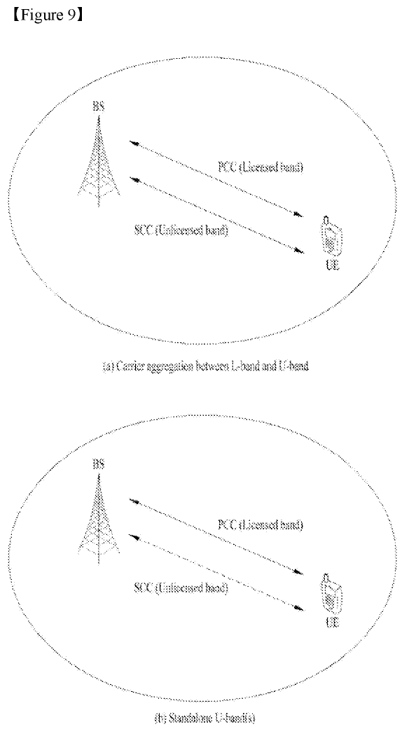

FIG. 9 illustrates an exemplary wireless communication system supporting an unlicensed band applicable to the present disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on carrier-aggregated LCC and UCC as illustrated in FIG. 9(a), the LCC and the UCC may be configured as a primary CC (PCC) and a secondary CC (SCC), respectively. The BS and the UE may transmit and receive signals on one UCC or on a plurality of carrier-aggregated UCCs as illustrated in FIG. 9(b). In other words, the BS and UE may transmit and receive signals only on UCC(s) without using any LCC. For an SA operation, PRACH, PUCCH, PUSCH, and SRS transmissions may be supported on a UCell.

Signal transmission and reception operations in an unlicensed band as described in the present disclosure may be applied to the afore-mentioned deployment scenarios (unless specified otherwise).

Unless otherwise noted, the definitions below are applicable to the following terminologies used in the present disclosure.

Channel: a carrier or a part of a carrier composed of a contiguous set of RBs in which a channel access procedure (CAP) is performed in a shared spectrum.
Channel access procedure (CAP): a procedure of assessing channel availability based on sensing before signal transmission in order to determine whether other communication node(s) are using a channel. A basic sensing unit is a sensing slot with a duration of Tsl=9 us. The BS or the UE senses the slot during a sensing slot duration. When power detected for at least 4 us within the sensing slot duration is less than an energy detection threshold Xthresh, the sensing slot duration Tsl is be considered to be idle. Otherwise, the sensing slot duration Tsl is be considered to be busy. CAP may also be called listen before talk (LBT).
Channel occupancy: transmission(s) on channel(s) from the BS/UE after a CAP.
Channel occupancy time (COT): a total time during which the BS/UE and any BS/UE(s) sharing channel occupancy performs transmission(s) on a channel after a CAP. Regarding COT determination, if a transmission gap is less than or equal to 25 us, the gap duration may be counted in a COT. The COT may be shared for transmission between the BS and corresponding UE(s).
DL transmission burst: a set of transmissions without any gap greater than 16 us from the BS. Transmissions from the BS, which are separated by a gap exceeding 16 us are considered as separate DL transmission bursts. The BS may perform transmission(s) after a gap without sensing channel availability within a DL transmission burst.
UL transmission burst: a set of transmissions without any gap greater than 16 us from the UE. Transmissions from the UE, which are separated by a gap exceeding 16 us are considered as separate UL transmission bursts. The UE may perform transmission(s) after a gap without sensing channel availability within a DL transmission burst.
Discovery burst: a DL transmission burst including a set of signal(s) and/or channel(s) confined within a window and associated with a duty cycle. The discovery burst may include transmission(s) initiated by the BS, which includes a PSS, an SSS, and a cell-specific RS (CRS) and further includes a non-zero power CSI-RS. In the NR system, the discover burst includes may include transmission(s) initiated by the BS, which includes at least an SS/PBCH block and further includes a CORESET for a PDCCH scheduling a PDSCH carrying SIB1, the PDSCH carrying SIB1, and/or a non-zero power CSI-RS.
   A Frame Structure with Time-Domain Reference Signals for Sub-THz Band

Meanwhile, 5G NR continues its expansion towards higher frequency bands to satisfy new requirements and applications. Recently, 3GPP considers wireless communication in sub-THz band (e.g., around 71-114 GHZ). In this band, the phase noise level becomes significantly higher than for common lower bands, and this issue should be addressed device individually (e.g., UE specifically). Design of advanced algorithms and PTRS signals within an established/existing frame formats may not be enough for performance requirements. Thus, design of the novel frame structure and corresponding waveforms is newly proposed in this document.

In the lower 5G NR bands (FR1 and partially FR2), the effects of the phase noise can be neglected in most cases. But in 52-71 GHz band, increased phase noise (PN) should be properly compensated.

Typically, for phase tracking and compensation of the phase noise (PN)-induced inter-carrier interference (ICI), a set of special reference signals (e.g., PTRSs) is allocated in frequency domain uniformly across the frequency domain user resources (subcarriers). The PTRSs can be used for the estimation of the phase noise realization and mitigation of the PN effects using a frequency domain convolutional filtering.

Estimation and application of the PN compensation filters can be complex computations. For the smaller subcarrier spacing (SCS) and correspondingly the longer OFDM symbol duration, acceptable level of the PN compensation can be achieved only with the convolutional filtering with up to7th-9th order filters. And, for the higher SCS and correspondingly the shorter OFDM symbols, simple one-tap phase noise compensation in frequency domain may be enough.

It can be more efficient to perform the PN estimation and compensation in the time domain, since the PN corresponds to a per-sample basis time domain signal. However, due to the design and structure of legacy OFDM symbol, the PN estimation and compensation in time domain is hardly applicable.

Similar behavior of the PN ICI is expected in the sub-THz band, so decreasing of the symbol duration and one-tap filter processing either in frequency or time domain is desired for the simplification of the PN handling.

At the same time, sub-THz transmission will suffer from the increased pathloss, and thus, highly directional, high gain antennas is necessary for path loss compensation. Communication channel created by signal propagation through a narrow-beam antenna will have a very small delay spread around the dominant line of sight (LOS) component. In this case, the requirements for the OFDM inter-symbol guard interval (cyclic prefix) can be eased.

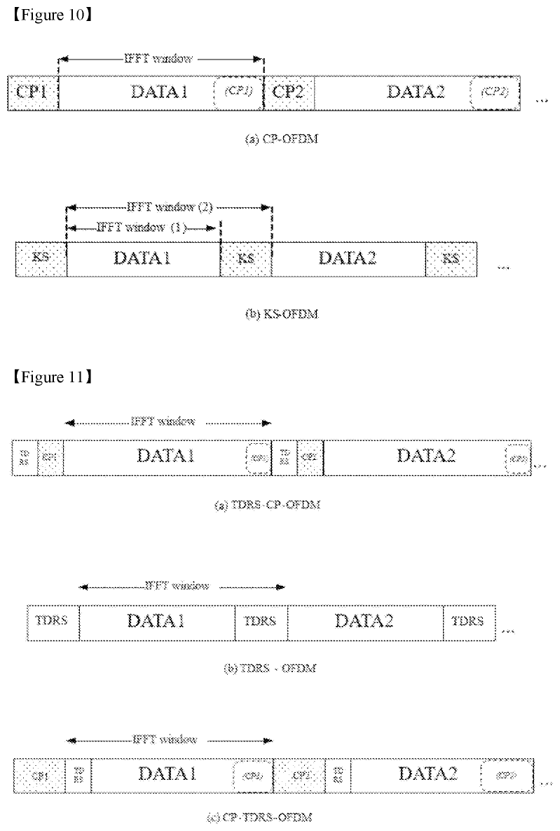

FIG. 10(a) illustrates a CP-OFDM structure (without TDRS). In CP-OFDM, each symbol starts with its CP that is generated by copying the end of a corresponding symbol. CP (Cyclic prefix) provides protection against Inter Symbol Interference (ISI) and Inter subcarrier Interference. Generally, delay spread may cause ISI because the delay spread components of symbol #n can be detected while receiving symbol #n+1. To reduce the ISI, CP can provide a guard period between the symbols #n and #n+1. If CP is used, the delay spread components of symbol #n can be received within the guard period by CP of symbol #n+1. Thereby the remaining part of the symbol #n+1 can be properly received without ISI. Meanwhile, to reduce the inter-subcarrier interference, the CP is configured to be a copy of the ending part of a corresponding symbol.

The CP duration should be properly designed in consideration of both CP overhead and the delay spread. In 4G LTE or 5G NR (which are the legacy CP-OFDM based wireless communication systems), two different CP types (Normal CP and Extended CP) are defined. The Exact CP length of a CP-OFDM symbol (without TDRS) is defined as Equation 2 in NR, as mentioned above. And, the CP length is determined in consideration of its SCS. Even though the current Rel. 15/16 NR supports 5 SCSs as shown in Table 2, Rel. 17 NR may cover other SCSs such as 480 kHz, 960 kHz. Moreover, the longer SCSs may be added/used for the sub-THz operations. Thus, (possible) CP length(s) of CP-OFDM for the sub-THz is not limited to the existing CP lengths in current NR system. That is, new CP length(s) can be defined for the sub-THz band operation (e.g., sub-THz band-dedicated CP). For example, the new CP length(s) can be determined by using the (same) Equation 2, but with the longer SCSs. Hereafter, the term “CP” may cover the CP lengths for the sub-THz band. Because the CP is generated by copying of the end of symbol payload, the time domain waveform of the CP quite depends on data in the symbol. That is, CP is not a known/fixed sequence and is differently generated for each symbol. In view of receiving side, the CP waveform is not predictable and it has a kind of random characteristic. Thus, the existing CP cannot be used as a pilot or reference signal.

### [Combination of the Waveforms]

Aforementioned factors lead to the requirements that future sub-THz waveform should have a time-domain reference signals for phase noise tasks and the adjustable guard interval duration for better adaptation to the channel conditions. At the same time, some level of compatibility with the current NR waveform is required.

The logical solution is to change the CP in the CP-OFDM (e.g., FIG. 10(a)) with the known sequence that may be used for phase noise tracking and general acquisition as shown in (FIG. 10(b)). In the literature, such approaches are called known symbol padding (KSP-OFDM) [2] [3], time-domain synchronous (TDS-OFDM), [4] and unique-word (UW-OFDM) [5].

The KSP-OFDM (hereafter “KSP”) and TDS-OFDM (hereafter “TDS) approaches include appending the known sequence in the time domain to the modulated OFDM symbol (FIG. 10(b), IFFT/FFT window I). This waveform requires complex signal processing for channel estimation and signal demodulation, since the known signal is leaked into the useful data due to multipath propagation.

The UW-OFDM (hereafter “UW”) approach, although identical from the time domain point of view, pretty different from KSP or TDS in terms of processing. For the UW, the IFFT window of Tx/FFT window of Rx should cover both data and known sequence, thus it keeps cyclic properties in the multipath channels (FIG. 10(b), IFFT/FFT window II). In this case, UW serves as proper guard interval, and with appropriate timing, the OFDM signal can be demodulated with the one-tap frequency domain equalization (FDE). However, the complexity of the approach with known sequence inside the FFT/IFFT window lies not in the demodulation of such signal, but rather in its generation (i.e., relatively low processing overhead at reception side, but relatively high processing overhead transmission side). Since the data OFDM signal is generated in the frequency domain, generation of the localized and separated data in time domain is not an easy and straight forward task. That is, the time period for the KS should be generated from IFFT in frequency domain by nulling/puncturing (or rate matching) on subcarriers corresponding to the time period, but there's high processing overhead in identifying the subcarriers before IFFT, which will be the time period for KS in time domain after the IFFT.

To make this possible, special reserved subcarriers may be allocated within a data resource blocks and special values can be assigned there to create a separated time-domain part of the frame for UW mapping.

Hereafter, for convenience, OFDM-based waveforms with known sequence in time domain can be called as time-domain reference signal (TDRS). TDRS can be used for the time domain phase noise compensation, which may be performed before the demodulation and even channel estimation, which significantly simplifies the processing. If PN at least partially compensated in the time domain before the FFT at the receiving side, the ICI may be reduced to in a level where the complex filtering processes are not necessary for compensation.

TDRS waveform, shown in FIG. 11(b) doesn't have the CP allocated and thus, timing division of the 1 ms subframe may be changed. In the 5G NR Rel-15 specification, the base subcarrier spacing is 15 kHz with 2\hat{ }u scaling to 30/60/120/240 kHz SCS. Normally it means that the 1 ms subframe may include 15/30/60/120 OFDM symbols, or 1/2/4/8 slots with 15 symbols each, according to SCSs. However, due to necessity of the CP, only 14 symbols per slot are allocated and the last (15th) symbol is proportionally divided between all other symbols as CP. That is, the 1 symbol length is distributed over 14 symbols (as CP). With the TDRS-OFDM approach, the CP is no longer needed, so the frame timing allocation can be made straight and simple, with equal allocations of 15 symbols per slot. It should be noted, that unlike the legacy CP-OFDM, the proposed TDRS approach requires having TDRSs at both sides of the data portion. Normally this is fulfilled due since the OFDM symbols are transmitted consecutively during a frame. But in the end of the frame, an additional TDRS should be added for ensuring the proper demodulation of the last symbol on the frame.

The proposed TDRS structure may be beneficial for both phase noise compensation and adaptation to the channel delay spread changes, however the full legacy compatibility may be required and the timing of 5G NR frame structure needs to be kept exactly. Considering these requirements, according to an embodiment of the present invention, combination of the CP and known sequence approaches are newly proposed for the TDRS structure (e.g., FIG. 11(a)).

In the case of FIG. 11(a), a smaller internal CP (hereafter, “Type A-CP”) may prevent the TDRS from affecting the data and keep circular property of the OFDM symbol, while TDRS part of the frame suits for phase tracking and possibly other acquisition tasks.

Such type of the frame also has legacy time structure and basic CP properties, so can be processed even with devices that have no TDRS processing capabilities.

Another option of the TDRS implementation is shown in FIG. 11(c). In this case, the TDRS is also generated inside the IFFT/FFT window along the data, but for the sake of keeping the frame timing numerology, the 5G NR like cyclic prefix (hereafter, “Type C-CP”) is added to every OFDM symbol as usual. The Type C-CP may be determined based on the Equation 2 and the longer SCSs for sub-THz band.

Thus, from the frame timing point of view, there are options which can exactly follow the 5G NR timing (FIGS. 11(a) and (c)). And In the pure-TDRS case (FIG. 11(b)) in which the CP is omitted, exactly 15*2\hat{ }u symbols can be assigned on the duration of the 1 ms subframe. In FIG. 11(b), timing alignment with the existing 5G NR occurs only at the subframe bounds.

### [TDRS Processing]

The main purpose of the TDRS sequence is the time-domain phase noise estimation with the constant phase, linear or more complex and accurate approximations. Such approach allows PN compensation in the time domain before the FFT procedure at receiving side, effectively decreasing the ICI before it appears.

Also TDRS may be used for a per-symbol timing correction and per-symbol channel estimation updates, which is especially important for the high-Doppler channels.

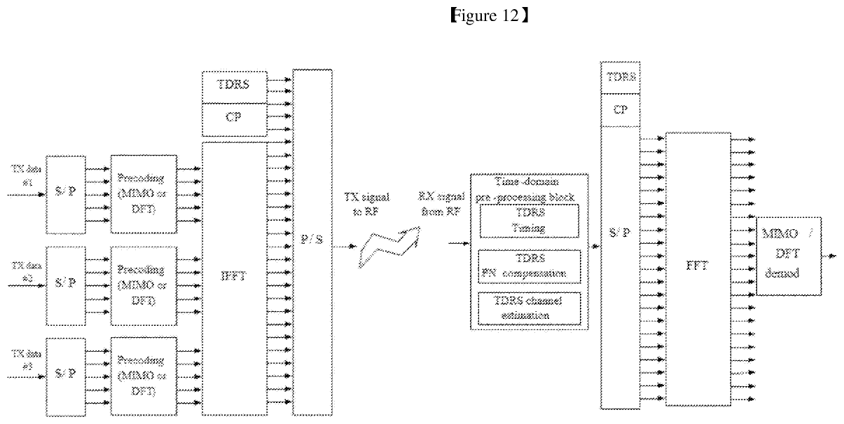

FIG. 12 illustrates exemplary TDRS-CP-OFDM processing flow (e.g., FIG. 11(a)). The processing flow of FIG. 12 can be applicable both for normal OFDM (CP-OFDM) and for DFT-S-OFDM waveforms, since the precoding block at the transmission side may perform either MIMO or DFT precoding to input signals.

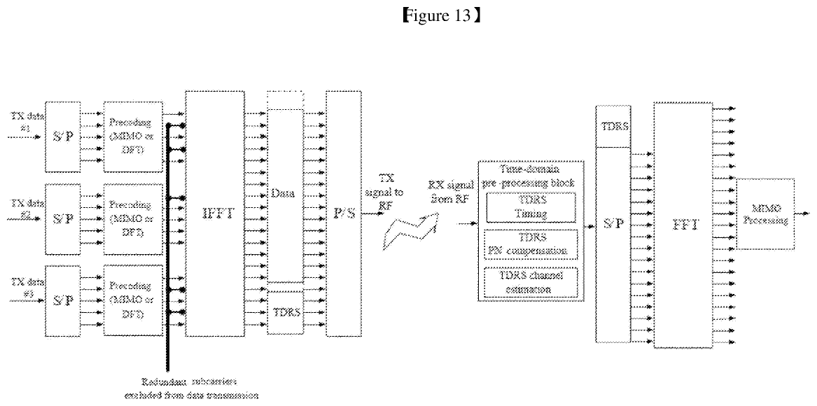

FIG. 13 illustrates TDRS OFDM processing according to an embodiment of the present invention. The processing flow of FIG. 13 can be used for FIG. 11(b) structure in which TDRS is included in the IFFT/FFT window.

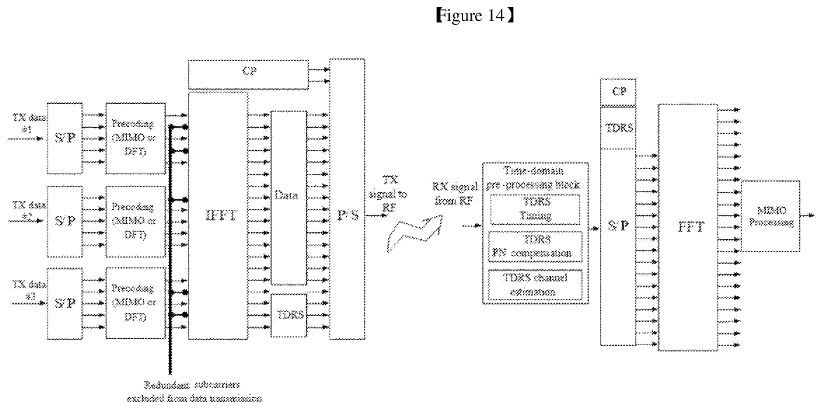

FIG. 14 illustrates CP-TDRS OFDM processing according to an embodiment of the present invention. The processing flow of FIG. 14 can be used for FIG. 11(c) structure in which TDRS is included in the IFFT/FFT window.

For the embodiments in which the TDRS is included into the FTT window (e.g., FIG. 11(b), (c)), the processing may be different, especially at the transmission side where non-trivial task of the time-separated sequences generation with a single FFT operation may be require. For this, a set of “redundant” subcarriers may be allocated within common data subcarriers for creation of the TDRS sequence via IFFT with the pre-defined required accuracy level as shown in FIG. 13. For example, the (modulated) data symbol on this redundant sub-carriers in TDRS-OFDM can be either punctured or the data can be rate-matched to align the transmit block size load with the actual reduced number of available subcarriers. However, details of the TDRS waveform generation are out of scope of present invention.

Meanwhile, the inside-FFT generated TDRS may not be necessarily placed in the beginning or end of the data part. Instead, the TDRS sequence can be separated in a one or several “blocks” that may be spread over the OFDM symbol duration. Such approach may allow more accurate approximation and estimation of the phase noise, but due to reduced duration of each TDRS block, susceptible to the impact of the multipath signal propagation.

### [Standard Impact]

To inform the receiving side about the TDRS existence and duration, a proper signaling should be introduced. In 5G NR system, the information about the cyclic prefix duration, as well as subcarrier spacing and bandwidth is transmitted through BWP information element (RRC signaling, [6], page 193).

For the support of TDRS, a new field, TDRS-Duration can be newly defined. For example, the TDRS-duration field can be added in the BWP information element. Or, the TDRS-duration field can be added in DCI using reserved bits or new DCI format can be defined.

The TDRS-Duration field may include information regarding a ratio of the TDRS duration and the CP duration (e.g., Type A-CP or Type C-CP). The available ratio values may include 0 and 1 (i.e., no TDRS and no CP cases) but not limited thereto, for example, intermediate ratio values ¾, ½, ¼ may be presented. It should be considered that in the 5G NR frame structure, every 0.5 ms a slightly longer CP is inserted (i.e., 320 samples versus 288 samples for FFT size 4096). For the proposed TDRS structures in the present invention, those extra samples (which were used as the longer CP in the legacy 5G NR frame structure) can be proportionally divided between TDRS and CP (e.g., Type A-CP or Type C-CP), or solely assigned to TDRS or CP only (e.g., Type A-CP or Type C-CP). The selection between options may be left as implementation specific or defined in the standard document.

For FIGS. 11(b) and (c) cases with the inside-FFT position of the TDRS, a similar TDRS duration signaling may be performed by DCI indication or other semi-static higher layer signaling. This signaling may include not only the TDRS duration, but also TDRS offset within a symbol and/or TDRS periodicity if TDRSs are not allocated contiguously.

Another option for the TDRS indication is extending the set of values of the (existing) cyclicPrefix field to cover a new set of possible values (in addition to the distinction between the normal and extended CP duration). In this case, cyclicPrefix field may also indicate TDRS as a fraction of the total CP duration. For instance, the total CP duration may refer to a new CP length(s) defined and supposed to be used for CP-OFDM symbol (e.g., FIG. 10(a) without TDRS) or TDRS-OFDM symbol (e.g., FIG. 11(b) only with TDRS) for sub-THz band (e.g., Equation 2 with the longer SCSs for sub-THz band). That is, the total CP duration may refer to a sum of a TDRS duration and an actual CP duration (e.g., Type A-CP or Type C-CP duration).

According to an embodiment of the present invention:
An OFDM-based waveform is newly proposed. Each OFDM symbol (e.g., TDRS-CP OFDM) in time domain may consist of the known time-domain reference signal part (e.g., TDRS), a cyclic prefix (CP) part and a data part. The TDRS-CP OFDM timing (e.g., duration of TDRS-CP OFDM symbol) can be time-aligned with the CP-OFDM timing (e.g., existing 5G NR CP-OFDM symbol duration. The TDRS and CP (e.g., Type A-CP or Type C-CP) durations (or the ratio between them) can be determined to optimize the system throughput with respect to wireless channel and transceiver impairments characteristics.
The duration of the TDRS with respect to the CP duration (e.g., Type A-CP or Type C-CP) is indicated by network.
The data part of the symbol can be generated using the CP-OFDM scheme or the CP-DFT-S-OFDM scheme.
In the case in which the symbol is comprised of the aforementioned TDRS part and data part only, both TDRS and data parts can be included in the FFT/IFFT window. The TDRS part may consist of one or more separate parts or sample blocks.
The proposed TDRS part can be used for the phase noise cancellation in the time domain before the conventional phase noise cancellation processing.
The TDRS part that may be used for the per-symbol timing estimation, and/or per-symbol channel estimation in the time domain with or instead of existing approaches. For example, if a presence of the proposed TDRS is signaled/indicated through network signaling (e.g., RRC or DCI), the frequency domain PT-RS (i.e., PTRS of existing 5G NR) may be disabled (not configured/transmitted).

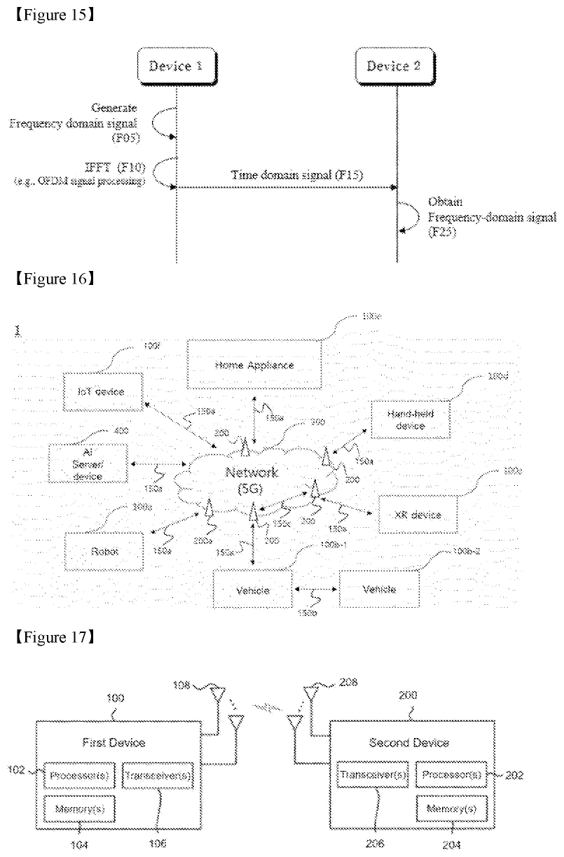

FIG. 15 illustrates a method of transmitting or receiving a signal according to an embodiment of the present invention.

Referring to FIG. 15, the device 1 may generate a frequency-domain signal (F05).

The device 1 may transmit a time-domain signal including one or more orthogonal frequency divisional multiplexing (OFDM) symbols (e.g., TDRS-CP-OFDM symbol or CP-TDRS-OFDM symbol) (F15) by performing an inverse fast Fourier transform (IFFT) based on the frequency-domain signal (F10). Each OFDM symbol in the time-domain signal may include a data part, a cyclic prefix (CP) part (e.g., Type A-CP or Type C-CP), and a time domain reference signal (TDRS) part. The TDRS part may include a known sequence that is predefined for phase noise compensation in a symbol level in a time-domain.

The device 2 may receive a time-domain signal including one or more orthogonal frequency divisional multiplexing (OFDM) symbols (F15).

The device 2 may obtain a frequency-domain signal by performing a fast Fourier transform (FFT) based on the time-domain signal (F25). Each OFDM symbol in the time-domain signal may include a data part, a cyclic prefix (CP) part (e.g., Type A-CP or Type C-CP), and a time domain reference signal (TDRS) part. The TDRS part may include a known sequence that is predefined for phase noise compensation in a time-domain.

The phase noise compensation can be performed by the device 2 in a symbol level in the time-domain based on the TDRS part in each OFDM symbol.

The device 1 may transmit information regarding a duration of the TDRS part through network signaling. The device 2 may obtain information regarding a duration of the TDRS part through network signaling.

The information regarding the duration of the TDRS part may indicate a ratio of the TDRS part and the CP part (e.g., Type A-CP or Type C-CP).

The network signaling may be downlink control information (DCI) or radio resource control (RRC) signaling.

The TDRS part and the CP part may be configured to share a fixed time duration in each OFDM symbol.

The fixed time duration may be identical to a CP duration of a CP-OFDM symbol in which the TDRS part is not configured. For instance, the CP duration may refer to a CP length per CP-OFDM symbol (e.g., FIG. 10(a) without TDRS) or a TDRS length per TDRS-OFDM symbol (e.g., FIG. 11(b) only with TDRS) for sub-THz band (e.g., Equation 2 with the longer SCSs for sub-THz band). That is, the CP duration may refer to a sum of the duration of the TDRS part and the duration of the CP part (e.g., Type A-CP or Type C-CP duration).

Both the TDRS part and the data part may be included in a FFT window for the FFT at the device 2. The FFT may be performed by assuming that data puncturing or data rate-matching has been performed for the TDRS part.

Both the TDRS part and the data part may be included in an IFFT window for the IFFT at the device 1. The IFFT may be performed after data puncturing or data rate-matching for the TDRS part.

The TDRS part of each OFDM symbol may include one or more sub-parts which are apart from each other.

FIG. 16 illustrates a communication system 1 can be applied to the present disclosure.

Referring to FIG. 16, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

FIG. 20 illustrates wireless devices applicable to the present disclosure.

Referring to FIG. 20, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

FIG. 18 illustrates another example of a wireless device applied to the present disclosure. The wireless device may be implemented in various forms according to a use case/service (refer to FIG. 16).

Referring to FIG. 18, wireless devices 100 and 200 may correspond to the wireless devices 100 and 200 of FIG. 16 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 20. For example, the transceiver(s) 114 may include the one or more transceivers 106 and 206 and/or the one or more antennas 108 and 208 of FIG. 20. The control unit 120 is electrically connected to the communication unit 110, the memory 130, and the additional components 140 and provides overall control to the wireless device. For example, the control unit 120 may control an electric/mechanical operation of the wireless on device based programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcasting terminal, a hologram device, a public safety device, an MTC device, a medical device, a FinTech device (or a finance device), a security device, a climate/environment device, the AI server/device (400 of FIG. 16), the BSs (200 of FIG. 16), a network node, or the like. The wireless device may be mobile or fixed according to a use case/service.

In FIG. 18, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

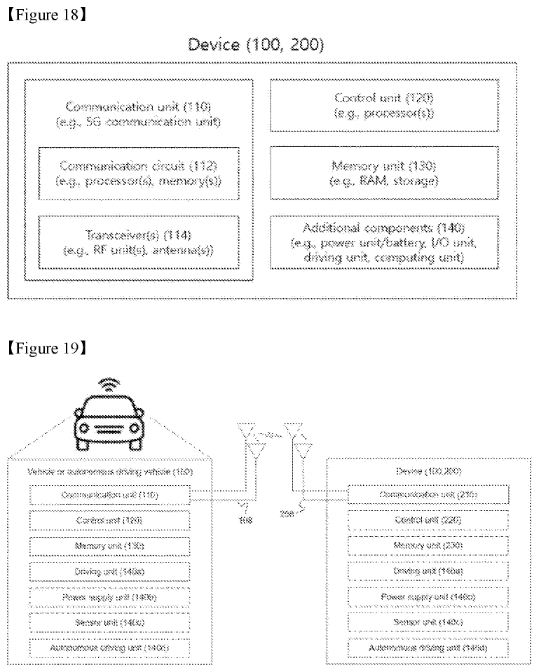

FIG. 19 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 18, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by a subsequent amendment after the application is filed.

The embodiments of the present disclosure have been described above, focusing on the signal transmission and reception relationship between a UE and a BS. The signal transmission and reception relationship is extended to signal transmission and reception between a UE and a relay or between a BS and a relay in the same manner or a similar manner. A specific operation described as performed by a BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the term fixed station, Node B, enhanced Node B (eNode B or eNB), access point, and so on. Further, the term UE may be replaced with the term terminal, mobile station (MS), mobile subscriber station (MSS), and so on.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure may be used in a UE, a BS, or other devices in a mobile communication system.

1. A method of receiving a signal by a device in a wireless communication system, the method comprising:
receiving a time-domain signal including one or more orthogonal frequency divisional multiplexing (OFDM) symbols; and
obtaining a frequency-domain signal by performing a fast Fourier transform (FFT) based on the time-domain signal,
wherein each OFDM symbol in the time-domain signal includes a data part, a cyclic prefix (CP) part, and a time domain reference signal (TDRS) part,
wherein the TDRS part includes a known sequence that is predefined for phase noise compensation in a time-domain, and
wherein the phase noise compensation is performed in a symbol level in the time-domain based on the TDRS part in each OFDM symbol.

2. The method according to claim 1, wherein information regarding a duration of the TDRS part is obtained through network signaling.

3. The method according to claim 2, wherein the information regarding the duration of the TDRS part indicates a ratio of the TDRS part and the CP part.

4. The method according to claim 2, wherein the network signaling is downlink control information (DCI) or radio resource control (RRC) signaling.

5. The method according to claim 1, wherein the TDRS part and the CP part are configured to share a fixed time duration in each OFDM symbol.

6. The method according to claim 5, wherein the fixed time duration is identical to a CP duration of a CP-OFDM symbol in which the TDRS part is not configured.

7. The method according to claim 1, wherein both the TDRS part and the data part are included in a FFT window for performing the FFT.

8. The method according to claim 1, wherein the TDRS part of each OFDM symbol includes one or more sub-parts which are apart from each other.

9. The method according to claim 1, wherein the device performs the FFT by assuming that data puncturing or data rate-matching has been performed for the TDRS part.

10. A device for wireless communication, the device comprising:
a memory configured to store instructions; and
a processor configured to perform operations by executing the instructions,
wherein the operations performed by the processor includes:
receiving a time-domain signal including one or more orthogonal frequency divisional multiplexing (OFDM) symbols; and
obtaining a frequency-domain signal by performing a fast Fourier transform (FFT) based on the time-domain signal,
wherein each OFDM symbol in the time-domain signal includes a data part, a cyclic prefix (CP) part, and a time domain reference signal (TDRS) part,
wherein the TDRS part includes a known sequence that is predefined for phase noise compensation in a time-domain, and
wherein the phase noise compensation is performed in a symbol level in the time-domain based on the TDRS part in each OFDM symbol.

11. A method of transmitting a signal by a device in a wireless communication system, the method comprising:
generating a frequency-domain signal; and
transmitting a time-domain signal including one or more orthogonal frequency divisional multiplexing (OFDM) symbols by performing an inverse fast Fourier transform (IFFT) based on the frequency-domain signal,
wherein each OFDM symbol in the time-domain signal includes a data part, a cyclic prefix (CP) part, and a time domain reference signal (TDRS) part, and
wherein the TDRS part includes a known sequence that is predefined for phase noise compensation in a symbol level in a time-domain.

12. The method according to claim 11, wherein information regarding a duration of the TDRS part transmitted through network signaling.

13. The method according to claim 12, wherein the information regarding the duration of the TDRS part indicates a ratio of the TDRS part and the CP part.

14. The method according to claim 12, wherein the network signaling is downlink control information (DCI) or radio resource control (RRC) signaling.

15. The method according to claim 11, wherein the TDRS part and the CP part are configured to share a fixed time duration in each OFDM symbol.

16. The method according to claim 15, wherein the fixed time duration is identical to a CP duration of a CP-OFDM symbol in which the TDRS part is not configured.

17. The method according to claim 11, wherein both the TDRS part and the data part are included in an IFFT window for performing the IFFT.

18. The method according to claim 11, wherein the TDRS part of each OFDM symbol includes one or more sub-parts which are apart from each other.

19. The method according to claim 11, wherein the device performs the IFFT after data puncturing or data rate-matching for the TDRS part.

20. A device for wireless communication, the device comprising:
a memory configured to store instructions; and
a processor configured to perform operations by executing the instructions,
wherein the operations performed by the processor includes:
generating a frequency-domain signal; and
transmitting a time-domain signal including one or more orthogonal frequency divisional multiplexing (OFDM) symbols by performing an inverse fast Fourier transform (IFFT) based on the frequency-domain signal,
wherein each OFDM symbol in the time-domain signal includes a data part, a cyclic prefix (CP) part, and a time domain reference signal (TDRS) part, and
wherein the TDRS part includes a known sequence that is predefined for phase noise compensation in a symbol level in a time-domain.
